(19) United States
(12) Patent Application Publication
(10) Pub. No.: US 2007/0078905 A1
(43) Pub. Date: Apr. 5, 2007

(54) Apparatus and Methods for a Do Not Disturb Feature on a Computer System

(75) Inventors: Adam Marshal Gunther, Raleigh, NC (US); Hugh Edward Hockett, Raleigh, NC (US); Eric F. Kirchstein, Raleigh, NC (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/163,097

(22) Filed: Oct. 5, 2005

(51) Int. Cl. G06F 17/30

(52) U.S. Cl. 707/201

(57) ABSTRACT

Techniques for implementing a do not disturb feature on a computer system are disclosed. To this end, a method includes establishing a public flag in memory whose status indicates whether a user of the computer system wants to be notified by a plurality of notifying applications. The method also includes communicating the status of the public flag to the notifying applications. Each notifying application has its own notifying feature which notifies the user of the computer system on an occurrence of an event. The method also includes suppressing the notifying feature in response to the status of the public flag.

The present invention generally relates to apparatus and methods for a do not disturb feature on a computer system, and more particularly, to advantageous systems, methods, and computer readable medium for informing software applications running on a computer system to suppress their notification of an occurrence of an event.

### BACKGROUND OF THE INVENTION

Many of today's software applications being run on a user's computer system include a notification feature such as a pop-up screen which typically informs the user that the associated application has become aware of something happening that may require the attention of the user. For example, Lotus Development Corp (Lotus) Sametime® Connect, an instant messaging application, displays a pop-up screen when another user wants to have an instant messaging session with the user. Additionally, Lotus Notes®, an electronic mail application, displays a pop-up screen when an incoming item of mail has arrived. These and other applications such as screen saver applications, print spoolers, and antivirus applications, all of which provide some sort of notification involving a pop-up screen feature, also typically provide a feature to allow the user to manually disable their own notification feature. For example, to disable notification when a new email arrives using Lotus Notes®, a user has to click on the file menu, and select the ‘preferences’ option to cause an options screen to appear. The user than must select the ‘Mail Tab’ and uncheck the “play a sound”, “show a popup”, and “show an icon in system tray” check box options. The user than clicks the “OK” button to save the changes.

Today's typical computer user may have many of these applications that have a notification feature. As a result, if the notification feature is not disabled for each application, the computer user may have his or her session with another running application interrupted, thus removing the computer user's focus from the current application to the interrupting application. For example, a user may be reading a complex document in a document editor and, during a period of intense concentration, be interrupted by another application's notification pop-up screen. Multiple interruptions by multiple applications may lower the productivity of the user.

While notification pop-up screens, notifying graphics, notifying messages, audible tones, flashing icons and the like, referred to collectively herein as notifying features, serve a useful purpose, many times these features become irritating or detrimental to the computer user. To avoid such interruptions, the computer user may be caused to manually disable each notifying feature from each application. As the number of applications which contain notifying features and are concurrently being run on a user's computer increases, such an approach typically becomes onerous for the computer user to disable each running application when he or she wishes not to be disturbed and then subsequently re-enable the notifying feature on each running application when he or she does not mind being disturbed or wants to be notified of something, such as incoming mail, for example.

This problem of interrupting notifications becomes amplified in the networked business world. Today, many companies hold corporate wide meetings which are stream casted live to individual employees' desktop computers. With each of these employees' desktop computers running applications that have notifying features which interrupt the viewing of the live broadcast, it may become difficult to focus all of the company's employees upon the corporate message being stream casted.

### SUMMARY OF THE INVENTION

The present invention recognizes the need to provide a system wide and network wide do not disturb feature on a computer system. A computer implemented method, a computer readable medium, and a computer system for a do not disturb feature on a computer system are disclosed. To this end, the computer implemented method includes establishing a public flag in memory whose status indicates whether a user of the computer system wants to be notified by a plurality of notifying applications. The computer implemented method also includes communicating the status of the public flag to the notifying applications. Each notifying application has its own notifying feature which notifies the user of the computer system on an occurrence of an event. The computer implemented method also includes suppressing the notifying feature in response to the status of the public flag.

One aspect of the present invention advantageously informs notifying applications that a user of the computer system desires that the notification feature of a notifying application be disabled or enabled. An aspect of the present invention allows a computer user to disable and enable the notifying feature of notifying applications which have been modified according to the teachings of the present invention with a single point of contact such as clicking on an icon in a system tray.

A more complete understanding of the present invention, as well as further features and advantages of the invention, will be apparent from the following Detailed Description and the accompanying drawings.

### BRIEF DESCRIPTION OF THE DRAWINGS

FIG. 1A shows an illustrative computer system employing a system wide do not disturb feature in accordance with the present invention.

FIG. 1B shows an illustrative network employing a network wide do not disturb feature in accordance with the present invention.

FIG. 2 shows a block diagram of computer program code in accordance with the present invention.

FIG. 3 is a flow chart illustrating a method for setting the do not disturb feature in accordance with the present invention.

FIG. 4 is a flow chart illustrating a polling method for a notifying application to determine whether to suppress its notifying feature in accordance with the present invention.

FIG. 5 is a flow chart illustrating an asynchronous method for informing a notifying application whether to suppress its notifying feature in accordance with the present invention.

### DETAILED DESCRIPTION

The present invention will now be described more fully with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

As will be appreciated by one of skill in the art, the present invention may be embodied as apparatus, methods, or computer program code. Accordingly, the present invention may take the form of an embodiment combining hardware and software aspects. Furthermore, the present invention may take the form of a computer-usable storage medium having computer-usable program code embodied in the medium. Any suitable computer readable medium may be utilized including hard disks, CD-ROMs, optical storage devices, flash memories, magnetic storage devices, and the like.

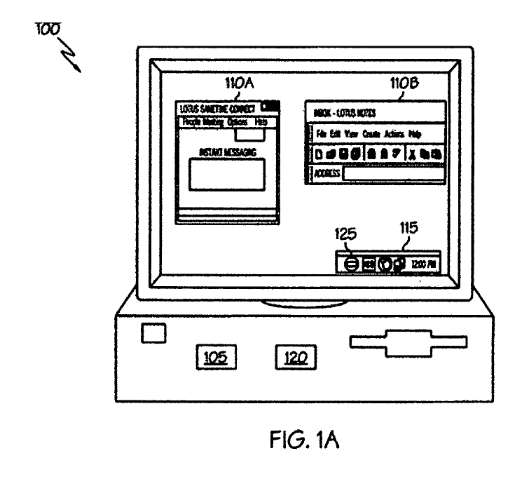

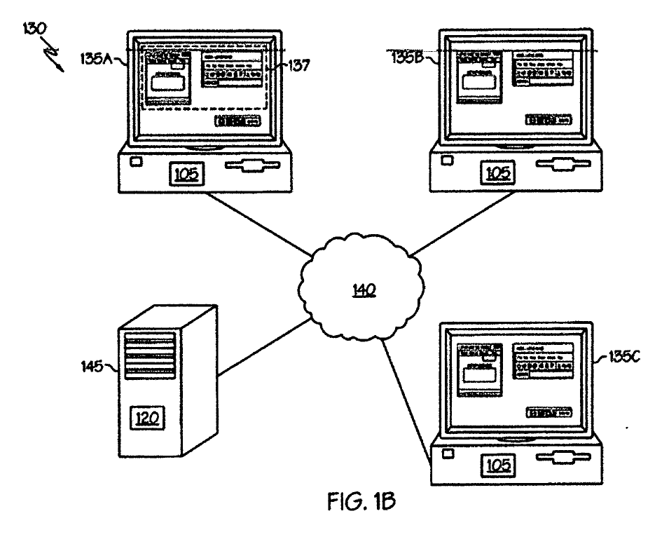

Computer program code or “code” for carrying out operations according to the teachings of the present invention may be written in various programming languages such as assembly, C, C++, Java, or other languages. Software embodiments of the present invention do not depend on implementation with a particular programming language. The program code may execute entirely on a user's computer, as a stand-alone software package, partly on the user's computer and partly on a remote computer or entirely on the remote computer. In the latter scenario which is discussed in further detail in FIG. 1B, the remote computer may be connected to the user's computer through a local area network (LAN) or a wide area network (WAN), or the connection may be made to an external computer, for example, through the Internet using an Internet Service Provider.

FIG. 1A shows an illustrative computer system 100 employing a system wide do not disturb feature in accordance with the present invention. Computer system 100 runs notifying applications 110A-110B and optionally a system tray application 115. Notifying applications 110A-110B have been modified according to the teachings of the present invention to execute code 105. The system tray application 115 or the operating system running on computer system 100 have been modified according to the teachings of the present invention to execute code 120. System tray application 115 optionally provides an icon 125 to allow the user of the computer system 100 to enable or disable the do not disturb feature from a single point of contact.

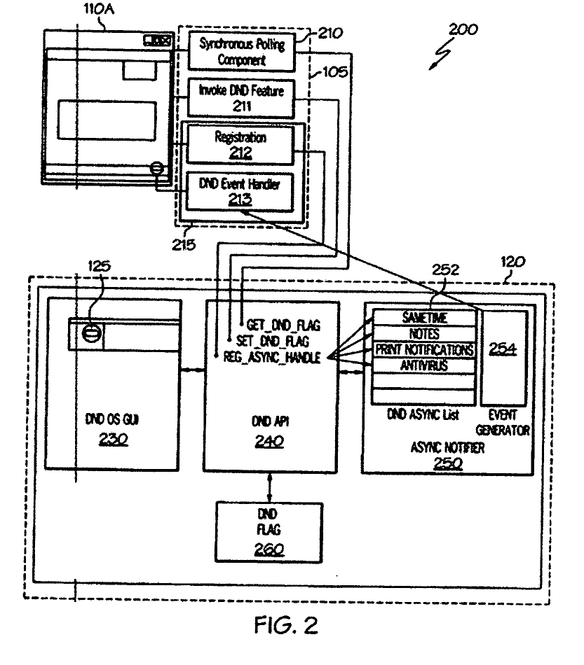

Computer code 105, when executed, allows its associated notifying application to voluntarily become aware that the user of computer system 100 wants to enable or disable the system wide do not disturb feature. Once aware, the notifying application decides whether to enable or disable its notifying feature accordingly. Computer code 120, when executed, informs each notifying application that the user of computer system 100 wants to enable or disable the system wide do not disturb feature. Computer code 105 and 120 will be described in further detail in connection with the discussion of FIG. 2.

FIG. 1B shows an illustrative network environment 130 employing a network wide do not disturb feature in accordance with the present invention. Network environment 130 includes a network 140 interconnecting a server 145 and computer systems 135A-135C. In this example, the server 145 executes code 120. Computer systems 135A-135C execute notifying applications 137 and their associated code 105. The notifying applications 137 register over the network with code 120 on server 145. A network administrator subsequently invokes the network do not disturb feature on server 145 which, in turn, informs each notifying application on computer system 135A-135C to enable or disable their respective notifying feature. Thus, all the notifying features for each of the registered notifying applications can be essentially turned on or off with a single point of contact such as by a network administrator clicking on an icon at the server, for example.

In this configuration, the system wide do not disturb feature as described in FIG. 1A is extended as a network wide do not disturb feature and is employed, for example, when a corporate on-line live communication is broadcasted to the computer desktops of employees. Such a network wide do not disturb feature reduces distraction caused by notifying applications and focuses the employees attention to the corporate communication.

It should be noted that other embodiments other than registering notifying applications directly with the server as described include registering each application with the computer system it runs on and, in turn, registering each computer with server 145. In this embodiment, both a system wide and a network wide do not disturb feature may coexist. For convenience, the remaining disclosure will refer to either the system wide and the network wide do not disturb feature as simply the do not disturb(DND) feature.

It should be noted that although the computer systems 100 and 135A-135C and server 145 are depicted as general purpose computers, the present invention applies to any computer system including a laptop, server, a workstation, a desktop, or the like which run computer program code 105, 120, or a combination of such devices in accordance with the present invention.

FIG. 2 shows a block diagram of computer program code 200 in accordance with the present invention. Computer program code 200 includes code 105 and code 120. The code 105 typically is embedded with a notifying application such as Lotus' Sametime® Connect application 110A. In order to determine the status of the do not disturb feature, the notifying application may include a synchronous polling component 210, an asynchronous component 215 which includes a registration component 212 and a do not disturb (DND) event handler 213, or both. The notifying application may optionally include an invoke feature DND component 211 which allows the notifying application to set the DND feature by invoking an application programming interface (API) in code 120. For example, a notifying application such as Lotus Sametime Connect may provide an option within its menus to allow a user to enable or disable the DND feature.

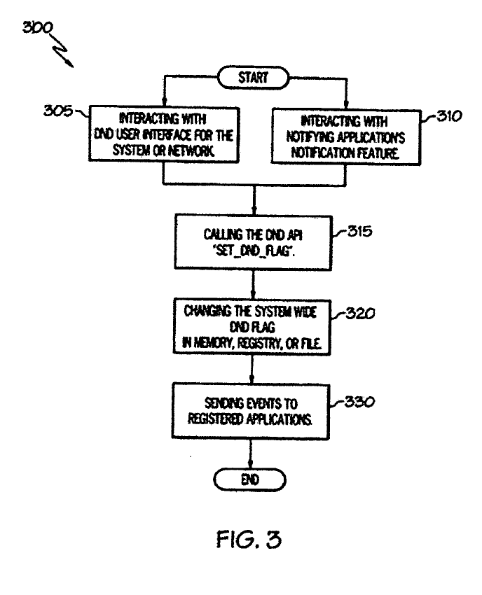

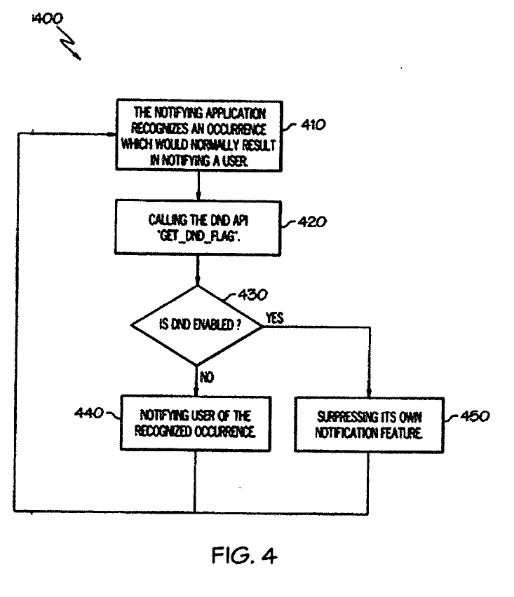

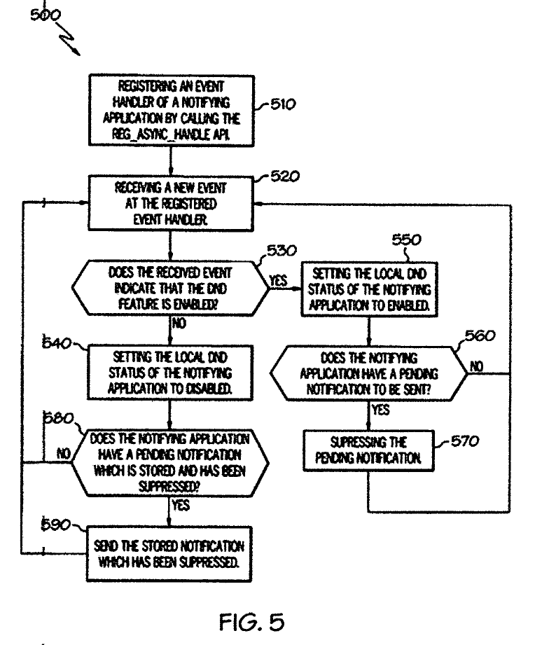

Further details of the synchronous polling component 210 will be described below in connection with the discussion of FIG. 4. Further details of the invoke feature DND component 211 will be described below in connection with the discussion of FIG. 3. Further details of the asynchronous component 215 will be described below in connection with the discussion of FIG. 5.

Code 120 includes a DND graphical user interface(GUI) 230, DND API component 240, an asynchronous notifier component 250, and a DND attribute 260. The DND GUI 230 provides a graphical indicator 125 which indicates whether the do not disturb feature is enabled or disabled. Furthermore, by clicking on the graphical indicator, the DND feature may be toggled between enable and disable. When the DND feature is enabled through DND GUI 230, DND GUI 230 calls the SET_DND_FLAG API in the DND API module 240 with a parameter to indicate enabling the DND feature. Likewise, when the DND feature is disabled through DND GUI 230, DND GUI 230 calls the SET_DND_FLAG API in the DND API module 240 with a parameter to indicate disabling the DND feature. In both cases, the SET_DND_FLAG API will set the DND flag 260 accordingly. The DND flag 260 may be stored in memory, a registry file, a flat file, or the like. The DND GUI 230 or code 120 as a whole may be employed in an operating system's system tray or may be a separate graphical application. Control of the DND flag 260 through DND GUI 230 provides the user of the computer or the network administrator a single point of contact from which to control all the notifying applications.

The DND API component 240 also includes a GET_DND_FLAG API which, when called, returns whether the DND feature is enabled or disabled and the REG_ASYNC_HANDLE API which, when called, registers or deregisters the location of the notifying applications. The location of a notifying application may include the address of the DND event handler associated with the notifying application or it may additionally include an internet protocol (IP) address of the computer system running notifying applications in a network wide DND embodiment or a remote procedure call (RPC) of the same. When the SET_DND_FLAG API is called, events are generated to the DND event handler of the registered notifying applications to inform them that the DND feature is enabled or disabled.

The asynchronous notifier component 250 includes a DND async list 252 and an event generator 254. The DND async list 252 stores the location of each registered notifying application. When a notifying application is registered, the location of the DND event handler of the notifying application is added to the DND async list 252. For example, DND async list 252 as depicted contains the location of Sametime, Notes, Print Notification, and Antivirus notifying applications. When a registered notifying application is deregistered, the location of the DND event handler of the notifying application is removed from the DND async list 252. The event generator creates event messages and sends them asynchronously to the DND event handlers of the notifying applications in the DND async list 252. More particularly, when the SET_DND_FLAG API is called, event generator 254 creates an event and sends a status change event to each notifying application found in the DND async list 252 that the status of the do not disturb feature has changed. The event may be sent by invoking the address of the DND event handler of a registered notifying application or transmitting it over a network using transmission control protocol/internet protocol (TCP/IP) to the notifying application. In general, the DND API and the asynchronous notifier component 215 provides public access to the DND flag 260 to one or more notifying applications.

FIG. 3 is a flow chart illustrating a method 300 for setting the do not disturb feature in accordance with the present invention. Two paths allow a user to express his or her desire to enable or disable the do not disturb feature. With regard to the first path defined by step 305, the user interacts with the DND user interface for the system or network such as DND GUI 230. In the case of a GUI, the user may click on a graphical representation of a DND button to either enable or disable the do not disturb feature. In the case of a keyboard user interface, a user may press a particular key or particular sequence of keystrokes in order to indicate whether to enable or disable the do not disturb feature.

A second path defined by step 310, alternatively or additionally, allows a user to express his or her desire to enable or disable the do not disturb feature. At step 310, the user interacts with one of the notifying applications such as an email application to enable or disable the DND feature. The notifying application may provide a separate system wide DND interface or may incorporate access to the DND feature through its existing user interface. For example, today's Microsoft® Outlook application can be customized to not display a notification message when new mail arrives by unchecking the box corresponding to the “display notification when new mail arrives” option. Step 310 allows a notifying application modified according to the teachings of the present invention to change its user interface to provide access for a user to the DND feature or to change the behavior of an existing option such as the display notification option to also invoke the DND feature.

Through either path, at step 315, the SET_DND_FLAG API such as the one disclosed in the DND API component 240 is invoked. In the first path, the DND user interface invokes the SET_DND_FLAG API. In the second path, the notifying application invokes the SET_DND_FLAG API. At step 320, the system wide DND flag such as DND flag 260 is changed in memory by DND API component 240. At optional step 330, asynchronous events are generated and sent to notifying applications which have been registered with an async notifier such as async notifier 250.

FIG. 4 is a flow chart illustrating a polling method 400 for a notifying application to determine whether to suppress its notifying feature in accordance with the present invention. The polling method 400 retrieves the current status of the DND feature. Typically, the polling method 400 is utilized when a notifying application begins running after code 120 has been running and the notifying application wants to determine the latest status of the DND feature.

At step 410, a notifying application recognizes an occurrence of an event which normally results in the notifying application informing the user of such an occurrence such as popping up a “new mail has arrived” screen. At step 420, the notifying application queries the status of the DND feature by calling the GET_DND_FLAG API such as the one described in FIG. 2 to receive the status of the DND feature. At step 430, the notifying application tests whether the DND feature is enabled. If the DND feature is not enabled, the method proceeds to step 440. At step 440, the notifying application notifies the user of the recognized occurrence such as popping up a screen, flashing an icon, displaying text, audible beeping, or the like. If the DND feature is enabled, the method proceeds to step 450. At step 450, the notifying application suppresses its own notification feature. After steps 440 or 450, the method proceeds to step 410 to wait for the next occurrence of an event which would typically result in notifying a user of the computer system. It should be noted that the notifying application may or may not store a notification that has been suppressed. If the notification is stored, the notifying application may then present the notifications to the user after the DND feature is disabled.

FIG. 5 is a flow chart illustrating an asynchronous method 500 for informing a notifying application whether to suppress its notifying feature in accordance with the present invention. At step 510, a notifying application registers itself with the code such as code 120 by calling the REG_ASYNC_HANDLE API as shown in FIG. 2. More particularly, the REG_ASYNC_HANDLE API stores the location of the notifying application's DND event handler such as DND event handler 213 in a DND async list such as DND async list 252. At step 520, the registered event handler receives a new event. This event is generated by event generator such as event generator 254 of FIG. 2. At step 530, the registered event handler determines the status of the DND feature. Step 530 may be implemented by parsing the DND status carried in the received event, or the notifying application may call the GET_DND_FLAG API. If the event indicates that the DND feature is enabled, the method proceeds to step 550. The notifying application may maintain a local DND status. In this case, if any subsequent occurrences which typically result in a notification are recognized, the notifying application would look at the local DND status to determine whether or not to suppress the notification. If so, at optional step 550, the notifying application would change the local DND status to enabled.

Optionally, method 500 may include steps 560 and 570 to handle a pending notification. A pending notification is a notification which has not yet been presented to the user. At step 560, the notifying application determines if there are any pending notifications. If there are no pending notifications, method 500 proceeds to step 520 to wait for and process the next event indicating a change in DND status. If there is a pending notification, method 500 proceeds to step 560. At step 570, the pending notification is suppressed by the notifying application. At the notifying application's option, the suppressed notification may be stored. Upon completion of step 570, the method 500 proceeds to step 520 to wait for and process the next event indicating a change in DND status.

Returning to step 530, if the event indicates that the DND feature is disabled, the method proceeds to optional step 540. At optional step 540, the notifying application would change the local DND status to disabled. Now with the local DND status set in the notifying application, if an occurrence of an event such as an arrival of new mail occurs, the notifying application would test the local DND status to determine whether to or not to suppress a notification. At the completion of step 540, the method proceeds to optional steps 580 and 590. Optional steps 580 and 590 handle suppressed notifications which have been stored. At step 580, method 500 determines whether the notifying application has any stored suppressed notifications. If so, method 500 proceeds to optional step 590 where any stored notifications which have been suppressed are now sent. Upon completion of step 590, the method 500 proceeds to step 520 to wait for and process the next event indicating a change in DND status.

While the present invention has been disclosed in the context of various aspects of presently preferred embodiments, it will be recognized that the invention may be suitably applied to other environments consistent with the claims which follow.

What is claimed is:

1. A computer implemented method for enabling a do not disturb feature on a computer system, comprising:
establishing a public flag in memory whose status indicates whether a user of the computer system wants to be notified by a plurality of notifying applications;
communicating the status of the public flag to the plurality of notifying applications, each notifying application having a corresponding notifying feature which notifies the user of the computer system of an occurrence of an event; and
suppressing the notifying feature of at least one of the plurality of notifying applications in response to the status of the public flag.

2. The computer implemented method of claim 1 wherein the notifying feature is a pop-up screen, audible tone, or flashing icon.

3. The computer implemented method of claim 1 further comprising:
modifying the public flag by utilizing a graphical user interface.

4. The computer implemented method of claim 1 further comprising:
modifying the public flag by at least one of the plurality of notifying applications.

5. The computer implemented method of claim 1 wherein the communicating the status of the public flag further comprises:
querying the public flag by at least one of the plurality of notifying applications.

6. The computer implemented method of claim 1 wherein the communicating the status of the public flag further comprises:
registering the notifying application for a status event message indicating that the public flag has had its value changed; and
sending the status event message indicating that the public flag has had its value changed to the registered notifying applications.

7. The computer implemented method of claim 6 wherein the sending the status event message further comprises:
sending the status event message over a network to a plurality of computer systems.

8. The computer implemented method of claim 1 wherein the notifying features of a portion of the plurality of notifying applications are different from each other.

9. A computer-readable medium whose contents cause a computer system to suppress notifications generated by a notifying application, by performing the steps of:
establishing a public flag in memory whose status indicates whether a user of the computer system wants to be notified by a plurality of notifying application;
communicating the status of the public flag to the plurality of notifying applications, each notifying application having its own notifying feature which notifies the user of the computer system on an occurrence of an event; and
suppressing the notifying feature of at least one of the plurality of notifying applications in response to the status of the public flag.

10. The computer-readable medium of claim 9 wherein the notifying feature is a pop-up screen, audible tone, or flashing icon.

11. The computer-readable medium of claim 9 further comprising:
modifying the public flag by utilizing a graphical user interface.

12. The computer-readable medium of claim 9 further comprising:
modifying the public flag by at least one of the plurality of the notifying applications.

13. The computer-readable medium of claim 9 wherein the communicating the status of the public flag further comprises:
querying the public flag by at least one of the plurality of the notifying applications to determine its status.

14. The computer-readable medium of claim 9 wherein the communicating the status of the public flag further comprises:
registering at least one of the plurality of the notifying applications for a status event message indicating that the public flag has had its value changed; and
sending the status event message indicating that the public flag has had its value changed to the registered notifying applications.

15. The computer-readable medium of claim 14 wherein the sending the status event message further comprises:
sending the status event message over a network to a plurality of computer systems.

16. The computer-readable medium of claim 9 wherein the notifying features of a portion of the plurality of notifying applications are different from each other.

17. A computer system for enabling a do not disturb feature on a computer system, comprising:
means for establishing a public flag in memory whose status indicates whether a user of the computer system wants to be notified by a plurality of notifying applications;
means for communicating the status of the public flag to the plurality of notifying applications, each notifying application having a corresponding notifying feature which notifies the user of the computer system of an occurrence of an event; and
means for suppressing the notifying feature of at least one of the plurality of notifying applications in response to the status of the public flag.

18. The computer system of claim 17 wherein the means for communicating the status of the public flag further comprises:
means for querying the public flag by at least one of the plurality of notifying applications.

19. The computer system of claim 17 wherein the means for communicating the status of the public flag further comprises:
means for registering at least one of the plurality of notifying applications for a status event message indicating that the public flag has had its value changed; and
means for sending the status event message indicating that the public flag has had its value changed to the registered notifying applications.

20. The computer system of claim 17 wherein the notifying features of a portion of the plurality of notifying applications are different from each other.
